(19) United States
(12) Patent Application Publication
(10) Pub. No.: US 2015/0113658 A1
(43) Pub. Date: Apr. 23, 2015

(54) MOBILE DEVICE AND METHOD FOR PROTECTING PRIVATE INFORMATION STORED IN MOBILE DEVICE

(71) Applicants: HON HAI PRECISION INDUSTRY CO., LTD., New Taipei (TW); HONG FU JIN PRECISION INDUSTRY (Wuhan) CO., LTD., Wuhan (CN)

(72) Inventors: WEN ZHONG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/135,604

(22) Filed: Dec. 20, 2013

(30) Foreign Application Priority Data
Oct. 22, 2013 (CN) 2013104979562

(51) Int. Cl. G06F 21/62; G06F 3/14

(52) U.S. Cl. CPC G06F 21/6245; G06F 3/14
USPC 726/26

(57) ABSTRACT

In a method for protecting private information stored in a mobile device, a first instruction is received to activate a private protection function of the mobile device. A second instruction is received to select a private information stored in the mobile device. The mobile device is connected to a pair of glasses and the selected private information is transmitted to the pair of glasses. The selected private information is displayed on a visual screen of the pair of glasses, and not displayed on a screen of the mobile device.

### BACKGROUND

1. Technical Field

The embodiments of the present disclosure relate to a mobile device and method for protecting private information stored in the mobile device.

2. Description of related art

Mobile devices, such as smart phones or tablet computers, are very popular. The mobile devices bring convenience to daily life. However, because the mobile devices are usually used in public places, private information stored in the mobile device is easy to leak, causing information security problems to users of the mobile devices.

### BRIEF DESCRIPTION OF THE DRAWINGS

FIG. 1 is a block diagram of one embodiment of a mobile device including a private information protection system.

FIG. 2 is a block diagram of one embodiment of function modules of the private information protection system in FIG. 1.

FIG. 3 is a flowchart of one embodiment of a method for protecting private information stored in a mobile device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

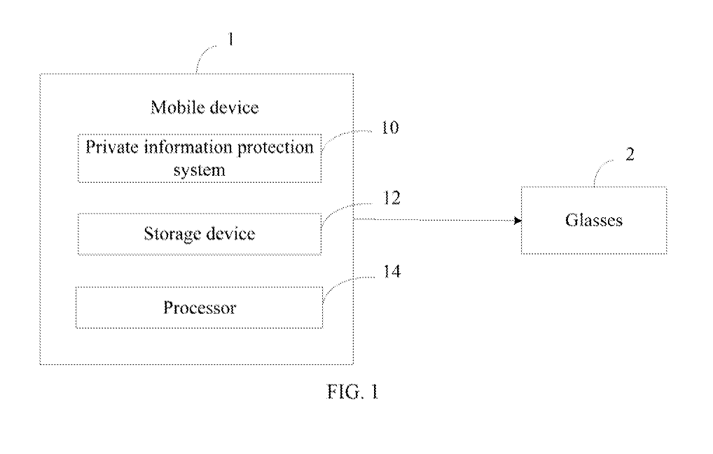

FIG. 1 is a block diagram of one embodiment of a mobile device 1 including a private information protection system 10. In the embodiment, the mobile device 1 may further include a storage device 12, and at least one processor 14. The mobile device 1 may be a cell phone, a notebook, or tablet computer, for example. The mobile device 1 may connect to a pair of glasses 2 through a wireless network.

The pair of glasses 2 comprises a projector configured to beam an image into eyes of a user wearing the pair of glasses 2, and generate a visual screen in front of a user of the mobile device 1, and further display selected information transmitted from the mobile device 1 on the visual screen using micro-cast technology.

In one embodiment, the storage device 12 (a non-transitory storage device) may be an internal storage system, such as a random access memory (RAM) for the temporary storage of information, and/or a accessed only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the private information protection system 10 includes a plurality of function modules which include computerized codes or instructions that can be stored in the storage device 12 and executed by the at least one processor 14 to provide a method for protecting private information stored in a mobile device 1.

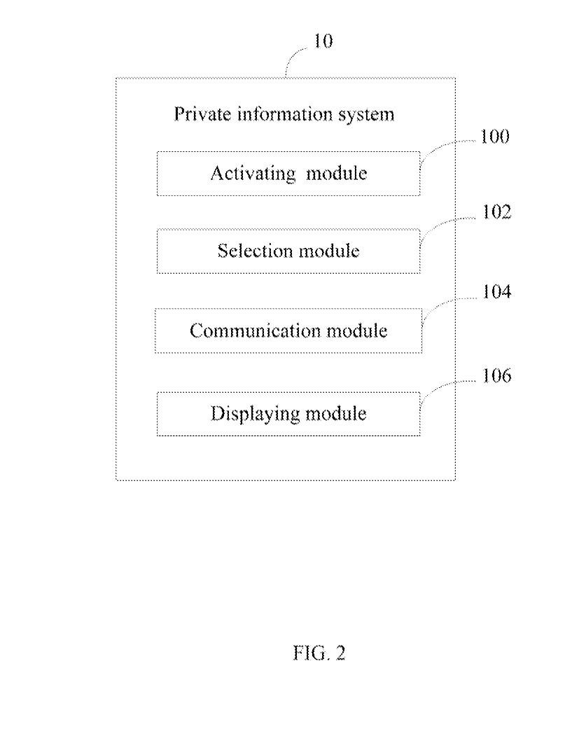

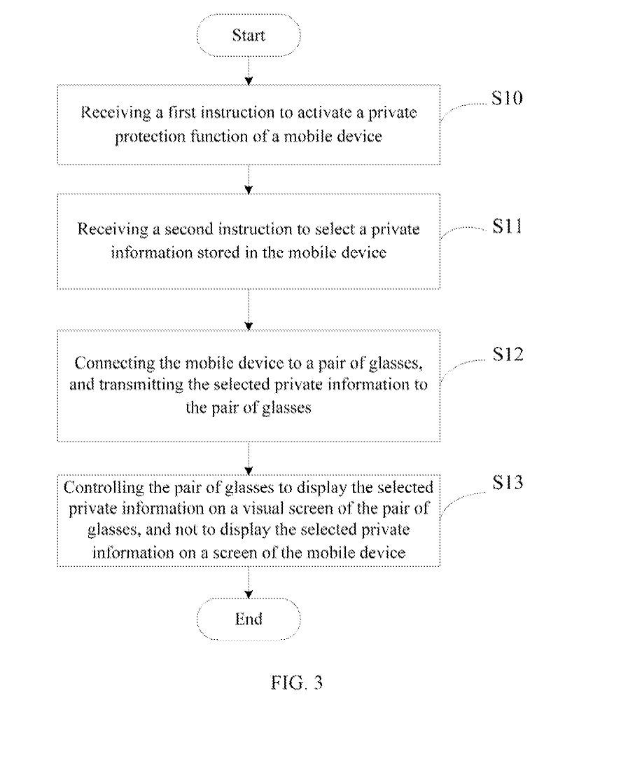

FIG. 2 is a block diagram of one embodiment of function modules of the private information protection system 10 in FIG. 1. In the embodiment, the private information protection system 10 includes an activating module 100, a selection module 102, a communication module 104, and a displaying module 106. The modules may comprise computerized codes in the form of one or more programs that are stored in the storage device 12 and executed by the at least one processor 14 to provide functions for implementing the private information protection system 10. The functions of the function modules are illustrated in FIG. 3 and described below.

FIG. 3 is a flowchart illustrating one embodiment of a method for protecting private information stored in the mobile device 1. Depending on the embodiment, additional steps may be added, others removed, and the ordering of the steps may be changed.

In step S10, the activating module 100 receives a first instruction to activate a private protection function of the mobile device 1. In the embodiment, the private protection function can force private information to be accessed through the pair of glasses 2, and not to be displayed on a screen of the mobile device 1 when the private information is accessed. The first instruction can be a first inputted key (e.g., a letter “S” key) from an input device of the mobile device 1.

In step S11, the selection module 102 receives a second instruction to select the private information stored in the mobile device 1. In the embodiment, the selected private information may be pictures, text files, or videos, for example. The second instruction can be a second inputted key (e.g., a letter “F” key) from an input device of the mobile device 1.

In step S12, the communication module 104 connects the mobile device 1 to the pair of glasses 2 through a wireless network(e.g., BLUETOOTH), and transmits the selected private information to the pair of glasses 2.

In step S13, the displaying module 106 controls the pair of glasses 2 to display the selected private information on a visual screen of the pair of glasses, and not to display the selected private information on the screen of the mobile device 1.

In the embodiment, the communication module 104 can encrypt a connection between the mobile device 1 and the pair of glasses 2. For example, the communication module 104 can control the visual screen to display a visual keyboard including numbers of 0-9, and decrypt the connection by receiving a predefined password inputted through the visual keyboard.

In the embodiment, the selected private information of the mobile device 1 can be directly displayed on the screen of the mobile device 1 if the private protection function of the mobile device 1 is not activated.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile device, comprising:
at least one processor; and
a storage device storing a computer program including instructions that, which executed by the at least one processor, causes the at least one processor to:
receive a first instruction to activate a private protection function of the mobile device;
receive a second instruction to select private information stored in the mobile device;
connect the mobile device to a pair of glasses, and transmit the selected private information to the pair of glasses; and
control the pair of glasses to display the selected private information on a visual screen of the pair of glasses, and not to display the selected private information on a screen of the mobile device.

2. The mobile device as claimed in claim 1, wherein the computer program further causes the at least one processor to:
encrypt a connection between the mobile device and the pair of glasses.

3. The mobile device as claimed in claim 2, wherein the computer program further causes the at least one processor to:
display a visual keyboard including numbers of 0-9 on the visual screen; and
decrypt the connection by receiving password inputted through the visual keyboard.

4. A method executed by a processor of a mobile device for protecting private information stored in the mobile device, the method comprising:
receiving a first instruction to activate a private protection function of the mobile device;
receiving a second instruction to select private information stored in the mobile device;
connecting the mobile device to a pair of glasses, and transmitting the selected private information to the pair of glasses;
controlling the pair of glasses to display the selected private information on a visual screen of the pair of glasses, and not to display the selected private information on a screen of the mobile device.

5. The method as claimed in claim 4, further comprising:
encrypting a connection between the mobile device and the pair of glasses.

6. The method as claimed in claim 5, further comprising:
display a visual keyboard including numbers of 0-9 on the visual screen; and
decrypting the connection by receiving password inputted through the visual keyboard.

7. A non-transitory computer-readable storage medium having stored thereon instructions being executed by a processor of a mobile device, causes the processor to perform a method for protecting private information stored in the mobile device, the method comprising:
receiving a first instruction to activate a private protection function of the mobile device;
receiving a second instruction to select private information stored in the mobile device;
connecting the mobile device to a pair of glasses, and transmitting the selected private information to the pair of glasses;
controlling the pair of glasses to display the selected private information on a visual screen of the pair of glasses, and not to display the selected private information on a screen of the mobile device.

8. The storage medium as claimed in claim 7, wherein the method further comprises:
encrypting a connection between the mobile device and the pair of glasses.

9. The storage medium as claimed in claim 8, wherein the method further comprises:
display a visual keyboard including numbers of 0-9 on the visual screen; and
decrypting the connection by receiving password inputted through the visual keyboard.
